(19) United States
(12) Patent Application Publication
(10) Pub. No.: US 2018/0305509 A1
(43) Pub. Date: Oct. 25, 2018

(54) LIGHT SHIELDING RESIN COMPOSITIONS

(71) Applicant: Samsung Electro-Mechanics Co., Ltd., Suwon-si (KR)

(72) Inventors: Geum-Hee YUN, Suwon-si (KR); Seol-Ah CHONG, Suwon-si (KR); Hwa-Young LEE, Suwon-si (KR); Ji-Hye SHIM, Suwon-si (KR); Sang-Eun SHIN, Suwon-si (KR)

(73) Assignee: Samsung Electro-Mechanics Co., Ltd., Suwon-si (KR)

(21) Appl. No.: 15/827,008

(22) Filed: Nov. 30, 2017

(30) Foreign Application Priority Data
Apr. 25, 2017 (KR) 10-2017-0053170

(51) Int. Cl. C08J 5/18; G02B 1/04; G02B 5/00

(52) U.S. Cl. CPC C08J 5/18; G02B 1/04; G02B 5/003; G01N 21/95; C08J 2400/24; C08J 2363/00; C08J 2300/00; C08J 2300/105

(57) ABSTRACT

A molded product includes a body comprising a light-shielding photosensitive resin. The light-shielding photosensitive resin has a tinting strength having an L value equal than or less than 40, an a* value of −40 to −10, and a b* value less than or equal to 5 in the L*a*b* color space (CIE colorimetric system), and the light-shielding photosensitive resin has a directed transmittance (% T) of less than 10% at a wavelength band of 200 nm to 700 nm.

### CROSS-REFERENCE TO RELATED APPLICATION(S)

This application claims the benefit under 35 USC § 119(a) of Korean Patent Application No. 10-2017-0053170 filed on Apr. 25, 2017, in the Korean Intellectual Property Office, the entire disclosure of which is incorporated herein by reference for all purposes.

### BACKGROUND

### 1. Field

The following description relates to light shielding resin compositions and a product comprising the same.

### 2. Description of Related Art

The field of Electro Magnetic Compatibility (EMC) has been identified as a “future growth engine,” That is, devices in the field of EMC have been selected as devices that will spur future regional economic growth since they can be integrated into a wide variety of products. Examples of EMC devices include Common Mode ESD Filters (CMEF), power inductors, high frequency beads, ESD filters, varistors, ESD Clamps, and ESD suppressors.

EMC devices are described as “universal electronic components,” referring to the characteristic that EMC devices may be applied to products in widely-varying fields, such as mobile phones, household appliances, and automobiles. With the spread of high-tech electronic devices and the increasing density of electromagnetic waves in the surrounding environment, the demand for high-performance electronic components able to operate in a higher frequency while having a lighter weight, a smaller size, and complex functionality, etc. is rapidly increasing.

In a conventional multilayer inductor, a laminate is formed by printing and lamination processes. The laminate is used to connect interlayer vias between a coil pattern and a coil on a ceramic insulating layer. An inductor is typically formed by compression, curing, or the like. With advancements in the miniaturization of composite electronic parts, high frequency multilayer inductors are also becoming smaller and thinner.

When inspecting defects of high frequency multilayer inductors, BGR illumination is used to inspect and detect uncoated external electrodes and coil exposures. During inspection, when a circuit is shown-through, it may be mistaken for a defect when the appearance is considered.

The width (W) and the thickness (T) of the high frequency multilayer inductor may be equal to each other due to the miniaturization, thinning, and high density, In this case, when inserted into a carrier tape, 90° misinsertion may occur due to burr or misalignment between the pocket and the chip. Furthermore, if the color of the upper and the side of a thin film high frequency inductor is the same, misinsertion may occur due to rotation, and defect detection may be impossible.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a molded product includes a body comprising a light-shielding photosensitive resin. The light-shielding photosensitive resin has a tinting strength having an L value equal than or less than 40, an a* value of −40 to −10, and a b* value less than or equal to 5 in the L*a*b* color space (CIE colorimetric system), and the light-shielding photosensitive resin has a directed transmittance (% T) of less than 10% at a wavelength band of 200 nm to 700 nm.

The light-shielding photosensitive resin may have a directed transmittance (% T) of less than 5% at a wavelength range of 200 nm to 700 nm.

The light-shielding photosensitive resin may include a carboxyl group-containing resin, a photopolymerization initiator, a diluting solvent, a photopolymerizable compound having an ethylenic unsaturated group, a thermosetting epoxy resin, a pigment, and an inorganic filler.

The pigment in the light-shielding photosensitive resin may be present in an amount or less than or equal to 2 parts by weight based on the total weight of solid content.

The inorganic filler in the light-shielding photosensitive resin may include spherical silica present in an amount greater than or equal to 60 parts by weight based on the total weight of solid content.

The spherical silica may have an average particle diameter of 500 nm to 1 μm.

The maximum particle diameter of the spherical silica may be less than 5 μm.

The light-shielding photosensitive resin may include an alkali developable light-shielding photosensitive resin.

The light-shielding photosensitive resin may include an alkali developable light-shielding photosensitive resin.

In another general aspect, a molded product includes a cover comprising a light-shielding thermosetting resin. The light-shielding thermosetting resin has a tinting strength of an L value of 40 to 100, an a* value of −6 or more, and a b* value of 30 or less in the L*a*b* color space (CIE colorimetric system), The light-shielding thermosetting resin has a directed transmittance (% T) of less than 1% at a wavelength band of 200 nm to 700 nm.

The light-shielding thermosetting resin may have a directed transmittance (% T) of 0.5% or less at a wavelength range of 200 nm to 700 nm.

The light-shielding thermosetting resin may include 60 to 80 parts by weight of an inorganic filler, 10 to 20 parts by weight of an epoxy resin, 0 to 10 parts by weight of a curing agent, 0 to 3 parts by weight of a polymer resin, and 0 to 10 parts by weight of a pigment based on the total weight of solid content.

The inorganic filler may include spherical silica having an average particle diameter of 500 nm to 5 μm.

The maximum particle diameter of the spherical silica may be 10 μm or less.

In another general aspect, a molded product includes a body including a light-shielding photosensitive resin and a cover covering one or more surfaces of the body, the cover including a light shielding thermosetting resin. The light-shielding photosensitive resin has a tinting strength having an L value equal than or less than 40, an a* value of −40 to −10, and a b* value less than or equal to 5 in the L*a*b* color space (CIE colorimetric system). The light-shielding photosensitive resin has a directed transmittance (% T) of less than 10% at a wavelength band of 200 nm to 700 nm. The light-shielding thermosetting resin has a tinting strength of an L value of 40 to 100, an a* value of −6 or more, and a b* value of 30 or less in the L*a*b* color space (CIE colorimetric system). The light-shielding thermosetting resin has a directed transmittance (% T) of less than 1% at a wavelength band of 200 nm to 700 nm.

The body and the cover may have a color difference (ΔE) greater than or equal to 30.

The body and the cover may have a color difference (ΔE) greater than or equal to 50.

The transmittance difference (% T) between the body and the cover may be greater than or equal to 6%.

The transmittance difference (% T) between the body and the cover may be 10% to 30%.

The molded product may be an inductor, a film, a printed circuit board, a light-shielding member, a chip, or a part for display on mobile phones or video devices.

The molded product may be a high frequency multilayer inductor having an equal width and thickness.

In another general aspect, a method for inspecting a molded product includes forming a molded product comprising a body and a cover disposed to overlap the body and inspecting the molded product for defects. The body includes a light-shielding photosensitive resin and the cover covers one or more surfaces of the body and includes a light shielding thermosetting resin. The light-shielding photosensitive resin has a tinting strength having an L value equal than or less than 40, an a* value of −40 to −10, and a b* value less than or equal to 5 in the L*a*b* color space (CIE colorimetric system). The light-shielding photosensitive resin has a directed transmittance (% T) of less than 10% at a wavelength band of 200 nm to 700 nm. The light-shielding thermosetting resin has a tinting strength of an L value of 40 to 100, an a* value of −6 or more, and a b* value of 30 or less in the L*a*b* color space (CIE colorimetric system). The light-shielding thermosetting resin has a directed transmittance (% T) of less than 1% at a wavelength band of 200 nm to 700 nm.

The body and the cover may have a color difference (ΔE) greater than or equal to 30.

The body and the cover may have a color difference (ΔE) greater than or equal to 50.

### BRIEF DESCRIPTION OF THE DRAWINGS

The patent or application file contains a least one drawing executed in color. Copies of this patent or patent application publication with color drawing(s) will be provided by the Office upon request and payment of the necessary fee.

FIG. 1 is a perspective view of an example of an inductor.

FIG. 2 is a cross-sectional diagram taken along line A-A of FIG. 1.

FIG. 3 illustrates results of appearance inspections.

FIG. 4 illustrates results of appearance inspections.

FIG. 5 is a UV-Vis absorption graph of an example of a light-shielding photosensitive film.

FIG. 6 is a UV-Vis absorption graph of an example of a thermosetting film.

FIG. 7 is a flowchart illustrating an example of a process for manufacturing a high frequency inductor.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur, Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

Light-Shielding Photosensitive Resin Composition

A light-shielding photosensitive composition may have a tinting strength having an L value less than or equal to 40, an a* value in the range of −40 to −10, and a b* value in the range of 5 or less in the L*a*b* color space (CIE colorimetric system) and a directed transmittance (% T) of less than 10% at a wavelength band of 200 nm to 700 nm.

An arbitrary position in the CIE color space is represented by three coordinate values of L*, a*, and b*. The L* value indicates the brightness. When L*=0, it indicates the darkest black, and when L*=100, it indicates the brightest white. The a* indicates whether the color having a corresponding color coordinate is shifted towards pure magenta (red) or pure green and the b* indicates whether the color having a corresponding color coordinate is shifted towards pure yellow or pure blue.

The a* has a range from −a to +a. The maximum value of a* (a* max) represents pure magenta (red), and the minimum value of a* (a* min) represents pure green. For example, if a* is a negative number, it indicates that the color is shifted towards the pure green color. If a* is a positive number, it indicates that the color is shifted towards the pure magenta (red) color. When a*=80 and a*=50 are compared, it indicates that a*=80 is closer to pure magenta (red) than a*=50.

The b* has a range from −b to +b. The maximum value of b* (b* max) represents pure yellow, and the minimum value of b* (b* min) represents pure blue. For example, if b* is a negative number, it indicates that the color is shifted towards the pure yellowish color; while if b* is a positive number, it indicates that the color is shifted towards the pure blue. When b*=50 and b*=20 are compared, it indicates that b*=50 is closer to pure yellow than b*=20.

The photosensitive resin composition according to the present description is not limited to the L*a*b* color space values described above, but may have tinting strength of an L value in a range of −100 to 40, an a* value in the range of −40 to −10, and a b* value in the range of −100 to 5.

The photosensitive resin composition described above improves the light-shielding characteristics of the molded product formed by the composition having a tinting strength as described above. Exceeding the tinting strength range may result in lack of light-shielding of the molded product. In this case, it may cause show-through problem of internal coils of a multilayer inductor under BGR illumination.

In general, the light transmitted through the optical filter can be divided into a component substantially parallel to the incident light and a scattered component. In this case, the transmittance of the component substantially parallel to the incident light is defined as directed transmittance (% T).

The photosensitive resin composition described above has a directed transmittance of less than 10%, which can improve light-shielding of a molded product manufactured with the composition described above. When it is deviated from the above-mentioned directed transmittance range, light-shielding of a molded product may be insufficient.

Although not limited thereto, the composition may have a directed transmittance (% T) of from greater than 0% to less than 5% at a wavelength range of 200 nm to 700 nm.

The light-shielding photosensitive resin composition may include one or more of carboxyl group-containing resin, a photopolymerization initiator, a diluting solvent, a photopolymerizable compound having an ethylenic unsaturated group, a thermosetting epoxy resin, a pigment, and an inorganic filler.

Examples of the carboxyl group-containing resin include, but are not limited to, carboxyl group-containing unsaturated compounds, for example, unsaturated carboxylic acid such as acrylic acid, methacrylic acid, α-ethyl acrylic acid and the like; unsaturated dicarboxylic acids such as maleic acid, fumaric acid, itaconic acid, endocis-bicyclo[2.2.1]hept-5-ene-2,3-dicarboxylic acid, methyl-endocis-bicyclo[2.2.1]hept-5-ene-2,3-dicarboxylic acid, and the like. The unsaturated carboxylic group-containing compound may also include unsaturated carboxylic acid derivatives. Examples of the unsaturated carboxylic acid derivative may include acid anhydrides, esters, acid halides, amides and imides of unsaturated carboxylic acids, and more particularly, acid anhydrides such as maleic anhydride, chloro maleic anhydride, butenyl succinic anhydride, tetra-hydrophthalic anhydride, citraconic anhydride and the like; esters such as monomethyl maleate, dimethyl maleate, and glycidyl maleate; and maleyl chloride, maleimide, and the like.

A content of the carboxyl group-containing resin is not limited, but may be 0.1 to 10 parts by weight. If it exceeds the above-mentioned content, alkali developability and solvent property may be deteriorated.

Examples of the photopolymerization initiator may include one or more of aromatic ketones such as benzophenone, 4-methylbenzophenone, N,N′-tetramethyl-4,4′-diaminobenzophenone (Michler's ketone), N,N′-tetraethyl-4,4′-diaminobenzophenone, 4-methoxy-4′-dimethylaminobenzophenone, 2-benzyl-2-dimethylamino-1-(4-morpholinophenyl)butanon-1-2-methyl-1-[4-(methylthio)phenyl]-2-morpholinopropanone-1; quinones such as 2-ethylanthraquinone, phenanthrenequinone, 2-tert-butylanthrenequinone, octamethylanthrenequinone, 1,2-benzanthraquinone, 2,3-benzanthraquinone, 2-phenylanthraquinone, 2,3-diphenylanthraquinone, 1-chloroanthraquinone, 2-methylanthraquinone, 1,4-naphthoquinone, 9,10-phenanthraquinone, 2-methyl-1,4-naphthoquinone, 2,3-dimethylanthraquinone; benzoin ether compounds such as benzoin methyl ether, benzoin ethyl ether, and benzoin phenyl ether; benzoin compounds such as benzoin, methylbenzoin and ethylbenzoin; benzyl derivatives such as benzyl dimethyl ketal; 2,4,5-triarylimidazole dimer such as 2,2′-bis(o-chlorophenyl)-4,5,4′,5′-tetraphenyl-1,2′-biimidazole, 2-(o-chlorophenyl)-4,5-biphenylimidazole dimer, 2-(o-chlorophenyl)-4,5-di(methoxyphenyl)imidazole dimer, 2-(o-fluorophenyl)-4,5-biphenylimidazole dimer, 2-(o-methoxyphenyl)-4,5-biphenylimidazole dimer, 2-(p-methoxyphenyl)-4,5-biphenylimidazole dimer and the like; acridine derivatives such as 9-phenylacridine, 1,7-bis(9,9′-acridinyl)heptane and the like; N-phenylglycine and N-phenylglycine derivatives; coumarin compounds, thioxanthone compounds, isoamyl benzoate; and the like.

A content of the photopolymerization initiator is not particularly limited, but may be 0.05 to 10 parts by weight, such as 1 to 3 parts by weight, based on the solid content excluding the solvent of the photosensitive resin composition.

If the content of the photopolymerization initiator is less than 0.05 parts by weight, curing of the photosensitive resin composition may be slow or may not begin correctly, and if the content of the photopolymerization initiator exceeds 10 parts by weight, the sensitivity of the photosensitive resin composition may become excessively high, so that the resolution may be degraded.

The diluting solvent is not limited thereto, but may include one or more of alcohols such as methanol, ethanol, n-propanol, isopropanol, ethylene glycol and propylene glycol; terpenes such as α- or β-terpineol; ketones such as acetone, methylethyl ketone, cyclohexanone, N-methyl-2-pyrrolidone; aromatic hydrocarbons such as toluene, xylene, and tetramethylbenzene; glycol ethers such as cellosolve, methylcellosolve, ethylcellosolve, carbitol, methylcarbitol, ethylcarbitol, butylcarbitol, propylene glycol monomethylethyl ether, propylene glycol monoethyl ether, dipropylene glycol monomethyl ether, dipropylene glycol monoethyl ether, triethylene glycol monomethyl ether, triethylene glycol monoethyl ether, diethylene glycol dimethyl ether, diethylene glycol ethylmethyl ether, diethylene glycol diethyl ether and the like; acetic acid esters such as ethyl acetate, butyl acetate, cellosolve acetate, ethyl cellosolve acetate, butyl cellosolve acetate, propylene glycol monomethyl ether acetate, propylene glycol monoethyl ether acetate, and the like. It may be possible to form a uniform composition in which light-shielding particles and color-adjusting particles are stably dispersed by dissolving and mixing them using several kinds thereof.

A content of the diluting solvent may be in a range of 10 to 2000 parts by weight based on 100 parts by weight of the photosensitive resin composition and may be used to adjust the solid content and the solution viscosity to appropriate levels by coating on a substrate.

The photopolymerizable compound having an ethylenic unsaturated group may be selected from one or more of: alkyl-based(meth)acrylates such as alkyl(meth)acrylate with an alkyl group having 1 to 22 carbon atoms including methyl(meth)acrylate, ethyl(meth)acrylate, propyl(meth)acrylate, butyl(meth)acrylate, pentyl(meth)acrylate, 2-ethylhexyl(meth)acrylate, heptyl(meth)acrylate, hexyl(meth)acrylate, octyl(meth)acrylate, nonyl(meth)acrylate, decyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate, icosyl(meth)acrylate, henicosyl(meth)acrylate, docosyl(meth)acrylate and the like, 1,3-propanediol di(meth)acrylate, 1,4-butanediol di(meth)acrylate, 1,6-hexanediol di(meth)acrylate, neopentylglycol di(meth)acrylate, bis(acryloxyneopentylglycol)adipate, bis(meth) acryloxyneopentylglycol)adipate, epichlorohydrin-modified 1,6-hexanediol di(meth)acrylate; Nippon Kayaku Kayalad R-167, hydroxypivalic acid neopentyl glycol di(meth)acrylate, caprolactone-modified hydroxypivalic acid neopentyl glycol di(meth)acrylate, Nippon Kayaku Kayarad HX-series alkyl(meth)acrylate, ethylene glycol di(meth)acrylate, diethylene glycol di(meth)acrylate, triethylene glycol di(meth)acrylate, tetraethylene glycol di(meth)acrylate, polyethylene glycol di(meth)acrylate, epichlorohydrin-modified ethylene glycol di(meth)acrylate; Nagase Denacol DA(M)-811, epichlorohydrin-modified diethylene glycol di(meth)acrylate; Nagase Denacol DA(M)-851, propylene glycol di(meth)acrylate, dipropylene glycol di(meth)acrylate, tripropylene glycol di(meth)acrylate, tetrapropylene glycol di(meth)acrylate, polypropylene glycol di(meth)acrylate, epichlorohydrin-modified propylene glycol di(meth)acrylate; Nagase Denacol DA(M)-911, tritmethylolpropane tri(meth)acrylate, ditritmethylolpropane tri(meth)acrylate, neopentyl glycol-modified tritmethylolpropane di(meth)acrylate; Nippon Kayaku Kayarad R-604, ethylene oxide-modified trimethylolpropane tri(meth)acrylate; Sartomer SR-454, propyleneoxide-modified tritmethylolpropane tri(meth)acrylate:(meth)acrylate; Nippon Kayaku TPA-310, epichlorohydrin-modified tritmethylolpropane tri(meth)acrylate; Nagase DA(M)-321, trimethylol propane-type(meth)acrylate, pentaerythritol tri(meth)acrylate, pentaerythritol tetra(meth)acrylate, stearic acid-modified pentaerythritol di(meth)acrylate; Doagosei Aronix M-233, dipentaerythritol hexa(meth)acrylate, dipentaerythritol monohydroxypenta(meth)acrylate, alkyl-modified dipentaerythritol poly(meth)acrylates; Nippon Kayaku Kayarad D-310, 320, 330, etc., caprolactone-modified dipentaerythritol poly(meth)acrylate; Nippon Kayaku Kayarad DPCA-20, 30, 60, 120, pentaerythritol (meth)acrylate, glycerol di(meth)acrylate, epichlorohydrin-modified glycerol tri(meth)acrylate; Nagase Denacol DA(M)-314, glycerol-based (meth)acrylates such as triglycerol di(meth)acrylate, dicyclopentanyl di(meth)acrylate, tricyclopentanyl di(meth)acrylate, cyclohexyl di(meth)acrylate, methoxylated cyclohexyl di(meth)acrylate; Sanyo National Pulp CAM-200, alicyclic (meth)acrylate, tris(acryloxyethyl)isocyanurate; Doagosei Aronix M-315, isocyanurate (meth)acrylates such as tris(methacryloxyethyl) isocyanurate, caprolactone-modified tris(acryloxyethyl) isocyanurate, caprolactone-modified tris(methacryloxyethyl) isocyanurate.

The thermosetting resin may include, but is not limited to, an epoxy resin, a polyimide, and a liquid crystal polymer (LCP), In the case of an amorphous epoxy resin, it can be easily formed into a film shape compared to a crystalline epoxy such as biphenyl type epoxy. When excessive amount of the thermosetting resin is used, it may interfere with the flow of magnetic flux in the molded product. It may be used in an amount of 1 to 10 parts by weight, such as 5 parts by weight or less, but is not limited thereto.

As the pigment used in the present description, all of the pigments satisfying the conditions according to the above description. For example, both organic pigments and inorganic pigments can be used, and white pigments such as tin oxide, black pigments and color pigments may be used alone or in combination.

Examples of black organic pigments may include one or more of perylene black, cyanine black, aniline black, and lactam black. Examples of the black inorganic pigment may include carbon black (lamp black, acetylene black, thermal black, channel black, furnace black and the like), chromium oxide, iron oxide, titanium black, titanium oxynitride, titanium nitride, strontium titanate, and ceria.

Examples of the color pigment, which can be used in combination with the black pigments, may include one or more of carmine 6B(C.I.12490), phthalocyanine green(C.I. 74260), phthalocyanine blue(C.I. 74160), lionol yellow(C.I.21090), lionol yellow GRO(C.I. 21090), benzidine yellow 4T-564D, victoria pure blue(C.I.42595), C.I. PIGMENT RED 97, 122, 149, 168, 177, 180, 192, 215, C.I. PIGMENT GREEN 7, 36, C.I. PIGMENT BLUE 15:1, 15:4, 15:6, 22, 60, 64, C.I. PIGMENT YELLOW 83, 139, C.I. PIGMENT VIOLET 23 and the like. Additionally or alternatively, white pigments, fluorescent pigments and the like may be also used.

A content of the pigment is not limited thereto, but may be used in an amount of 2 parts by weight or less based on the total weight of the solid content. When the amount is more than 2 parts by weight, the shading rate may be lowered and the shading effect may not increase proportionally with addition of the pigment.

As the inorganic filler, spherical silica be used, and an average particle diameter of 500 nm to 1 μm and the maximum particle diameter of not more than 5 μm may be suitable for uniform photo-curing.

The inorganic filler may be spherical silica in an amount of at least 60 parts by weight, based on the total weight of the solid content, but is not limited thereto.

The photosensitive resin composition may include silica in an amount of 60 parts by weight or more and may include at least one alkali developable epoxy resin.

The composition may include, but is not limited to, a color alkali developable photosensitive resin.

Examples of the developing solution for this development may include one or more of inorganic alkaline solutions such as sodium hydroxide, potassium hydroxide, sodium silicate, sodium metasilicate, and ammonia; primary amines such as ethylamine and N-propylamine; secondary amines such as diethylamine and di-n-propylamine; tertiary amines such as trimethylamine, methyldiethylamine and dimethylethylamine; tertiary alcohol amines such as dimethylethanolamine, methyldiethanolamine and triethanolamine; cyclic tertiary amines such as pyrrole, piperidine, n-methylpiperidine, n-methylpyrrolidine, 1,8-diazabicyclo[5.4.0]-7-undecene, 1,5-diazabicyclo[4,3,0]-5-nonene; aromatic tertiary amines such as pyridine, coridine, lutidine and quinoline; and quaternary ammonium salts such as tetramethylammonium hydroxide and tetraethylammonium hydroxide.

Light-Shielding Thermosetting Resin Composition

A shielding thermosetting resin composition according to the present description may have tinting strength of an L value of 40 to 100, an a* value of −6 or more, and a b* value of 30 or less in the L*a*b* color space (CIE colorimetric system); and a directed transmittance (% T) of less than 1% at a wavelength band of 200 nm to 700 nm.

The a* value of the thermosetting resin composition may be in a range of −6 to 100, the b* value may be in a range of −100 to 30, and the transmittance may be in a range of 0% or greater to less than 1% at a wavelength range of 200 nm to 700 nm, but it may be not limited thereto.

The above-described thermosetting resin composition may improve light-shielding of a molded product formed by the above-described composition having the above-described tinting strength. When the tinting strength is deviated from the above range, it may result in reduced light-shielding of the molded product. Thus, there may be a show-through problem of internal coils of a multilayer inductor under BGR illumination when the range is deviated from.

The thermosetting resin composition described above has a transmittance of less than 1%, which may improve the light-shielding of a molded product manufactured by the composition described above. When the transmittance is deviated from the above-mentioned transmittance range, light-shielding of a molded product may be insufficient.

Although not limited thereto, the directed transmissivity (% T) of the thermosetting resin composition may be about 0.5% or less at a wavelength range of 200 nm to 700 nm.

According to the above-described thermosetting resin composition, the thermosetting resin composition may comprise 60 to 80 parts by weight of an inorganic filler, 10 to 20 parts by weight of an epoxy resin, 0 to 10 parts by weight of a curing agent, 0 to 3 parts by weight of a polymer resin, and 0 to 10 parts by weight of a pigment, 0 to 2 parts by weight of a dispersant or a curing accelerator based on the total weight of solid content.

The inorganic filler may be glass fiber or barium sulfate, but it is not limited thereto. The inorganic filter may improve impact resistance when it is produced as a molded product.

When an amount of the inorganic filler is less than 60 parts by weight, the strength and impact resistance may be lowered and the weight may be also lowered. When an amount of the inorganic filler is more than 80 parts by weight, the production process may experience a higher rate of defect or failure due to high weight and high rigidity.

The inorganic filler may include at least one kind of spherical silica. The average particle diameter may be 500 nm to 5 μm and the maximum particle diameter may not exceed 10 μm.

When the average particle diameter of the inorganic filler is less than 500 nm, the stiffness effect may be insufficient during mixing. When the average particle diameter is more than 5 μm, the molded product may be deteriorated and/or the appearance may be poor.

The epoxy resin may be, but is not limited to, a mono or polyepoxy resin. Examples of the epoxy resin may include butyl glycidyl ether, hexyl glycidyl ether, phenyl glycidyl ether, aryl glycidyl ether, para-tert-butylphenyl glycidyl ether, ethylene oxide, propylene oxide, paraxylyl glycidyl ether, glycidyl acetate, glycidyl butyrate, glycidyl hexoate, glycidyl benzoate, bisphenol-type epoxy resins obtained by glycidylating bisphenols such as bisphenol A, bisphenol F, bisphenol AD, bisphenol S, tetramethyl bisphenol A, tetramethyl bisphenol F, tetramethyl bisphenol AD, tetramethyl bisphenol S, tetrabromo bisphenol A, tetrachloro bisphenol A, tetrafluoro bisphenol A; epoxy resins obtained by glycidylating other divalent phenols such as biphenol, dihydroxynaphthalene and 9,9-bis(4-hydroxyphenyl) fluorene; epoxy resins obtained by glycidylating trisphenols such as 1,1,1-tris(4-hydroxyphenyl) methane, and 4,4-(1-(4-(1-(4-hydroxyphenyl)-1-methylethyl)phenyl) ethylidene) bisphenol; epoxy resins obtained by glycidylating tetrakisphenols such as 1,1,2,2-tetrakis(4-hydroxyphenyl) ethane; epoxy resins obtained by glycidylating novolaks such as phenol novolak, cresol novolak, bisphenol A novolak, brominated phenol novolak, brominated bisphenol A novolak; epoxy resins obtained by glycidylating polyphenols, aliphatic ether type epoxy resins obtained by glycidylating polyalcohols such as glycerin and polyethylene glycol; ether ester type epoxy resins obtained by glycidylating hydroxycarboxylic acids such as p-oxybenzoic acid, β-oxynaphthoic acid; ester type epoxy resins obtained by glycidylating polycarboxylic acids such as phthalic acid and terephthalic acid; glycidylates of amine compounds such as 4,4-diaminodiphenylmethane and m-aminophenol; amine type epoxy resins such as triglycidyl isocyanurate; alicyclic epoxides such as 3,4-epoxycyclohexylmethyl-3′,4′-epoxycyclohexanecarboxylate; and the like.

The epoxy resin may be a polyepoxy resin from the viewpoint of storage stability. If the epoxy resin is used in less than 10 parts by weight, the formation process of a molded product may be difficult.

The polymer resin may be a polyimide (PI) resin, a C-PVC resin, a PVDF resin, an ABS resin or a CTFE resin and may further include a hard coating agent, a UV blocking agent, an IR Blocking agent, and the like.

The dispersing agent may be a polymeric, nonionic, anionic, or cationic dispersing agent. Examples of the dispersing agent may include polyalkylene glycols and esters thereof, polyoxyalkylene polyhydric alcohols, ester alkylene oxide adducts, alcohol alkylene oxide adducts, sulfonic acid esters, sulfonate salts, carboxylic acid esters, carboxylic acid salts, alkylamide alkylene oxide adducts, alkylamines, and the like. One or a mixture of two or more selected from these may be used, but it is not limited thereto.

Molded Product

A molded product may comprise one or both of, for example: a body comprising the photosensitive composition and a cover comprising the photosensitive composition.

Hereinafter, a multilayered inductor will be described as an example of the molded product.

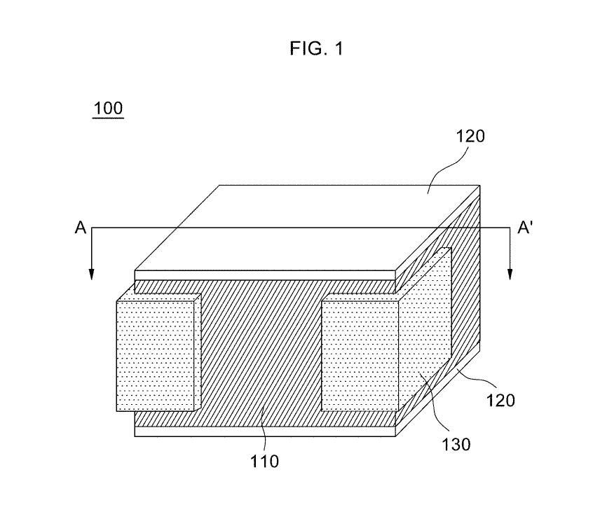

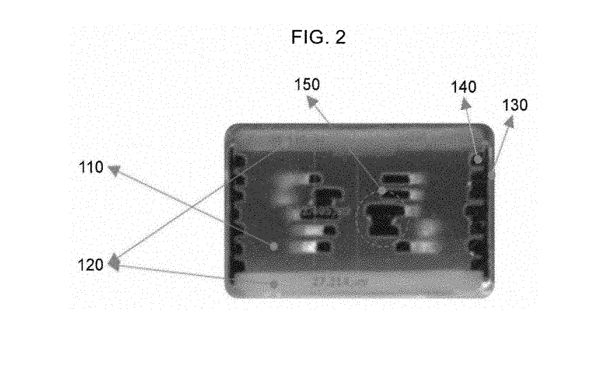

FIG. 1 is a perspective view of an inductor including a body made of a light-shielding photosensitive resin composition according to the above description and a cover made of a light-shielding thermosetting resin composition according to the above description. FIG. 2 is a cross-sectional diagram taken along line A-A of FIG. 1.

Referring to FIG. 1 and FIG. 2, a multilayer inductor 100 includes a body 110 formed by an inner insulating material of the inductor 100, a cover 120 forming the upper and lower surfaces of the body 110, an external electrode 130 formed at a corner of the body 110, a coil 140 embedded in the body 110, and a via 150 passing through the coil 140.

The body 110 is formed of a light-shielding photosensitive resin composition having excellent tinting strength according to the above description for a light-shielding photosensitive resin composition.

The cover 120 is formed of a light-shielding thermosetting resin composition having excellent in tinting strength according to the above description for a light-shielding thermosetting resin composition, distinguishable from the body 110, and capable of recognizing a direction of the device.

The tinting strength is an important characteristic that affects the appearance of a printed wiring board and concealability of a circuit. In conventional inductors, phthalocyanine-based green and blue and auxiliary yellow coloring agents are generally added to materials. These coloring agents all have a large absorption in the ultraviolet light region. If the amount absorbed is large, the ultraviolet light transmittance is affected and it becomes difficult to obtain good resolution.

However, when the tinting strength is insufficient, copper circuits formed on the printed wiring board are showed-through, so that a yield rate is significantly lowered when the appearance is screened. In recent years, a process for inspecting external appearance of the printed wiring board has been automated. Thus, it may be difficult to recognize the front/rear and start (S) surfaces during image recognition when parts are attached by a machine.

In particular, in case of a thin film high frequency inductor, it is impossible to detect defects when erroneous insertion is caused due to rotation because it is a bottom surface electrode type having the same color of top/side surfaces. An undetected defect such as this one may would cause the device to malfunction at a high rate when a defective product is distributed.

As described above, the body 110 and the cover 120 may be respectively prepared by using a photosensitive resin composition capable of being used as an insulating layer having acceptable light-shielding properties and high resolution, and a thermosetting resin composition having acceptable light-shielding properties.

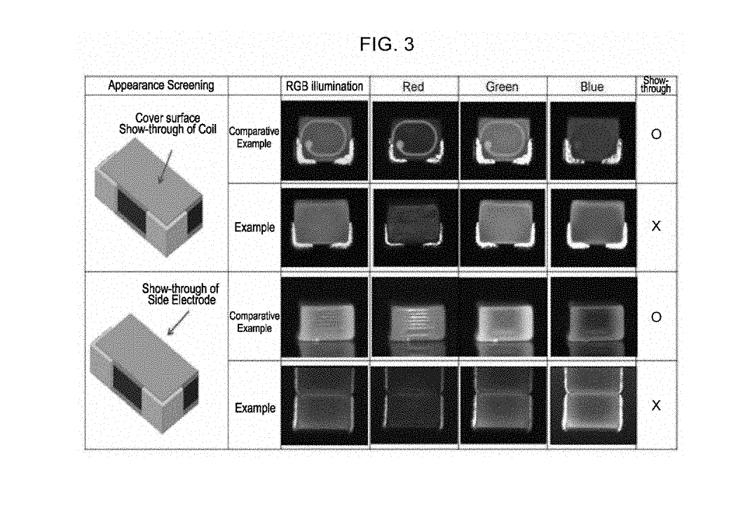

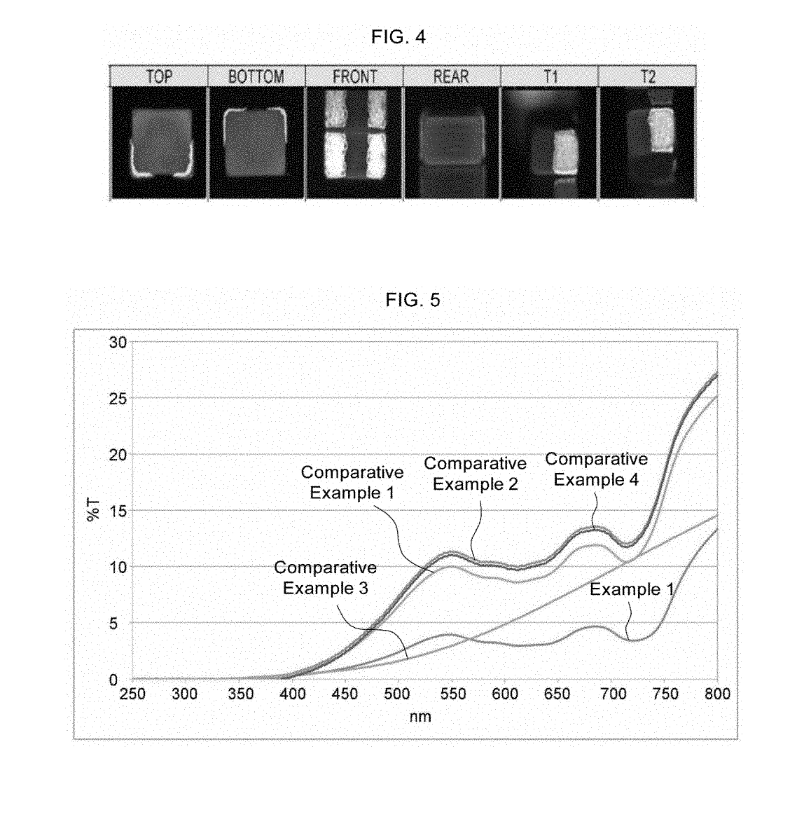

Therefore, when the thin film high-frequency multilayer inductor is inspected, the appearance of the body 110 and the cover 120 can be distinguished and the directionality of the inductor can be recognized without show-through problem of a coil under the appearance screening illumination (see FIG. 3 and FIG. 4).

According to the above, it is possible to distinguish the body 110 and the cover 120 and their respective deposition directions, even when the width W and the thickness T are the same.

Furthermore, using the cover 120, it is possible to determine whether a crack or other deformity is present without any show-through of circuits, even if it is a white system. The cover 120 may therefore be opaque white, though it is not limited thereto.

Although an inductor using body 110 and cover 120 is described above, this is merely exemplary. For instance, a molded product include be an inductor, a capacitor, a resistor, a capacitor, a color filter, a film, a printed circuit board, a light shielding member, a chip, or a part for display on mobile phones or video devices.

The above described molded product may be applied not only to mobile devices, but also to entire electric devices such as a camera, an audio, an electronic control unit (ECU), and an automobile part.

A molded product may comprise a body 110 made of a light-shielding photosensitive resin composition and a cover 120 made of a light-shielding thermosetting resin composition. The body 110 and the cover 120 have a color difference (ΔE) equal to or greater than 30.

Accordingly, the color difference is a concept used in the CIE Lab color space, which is a color value defined by CIE (Commission Internationale de l'eclairage). The color space of the CIE Lab is a color coordinate space expressing a difference in color that can be detected by human eyesight. The distances of two different colors in the CIE Lab color space are designed to be proportional to the difference in color recognized by human. The color difference in the CIE Lab color space refers to the distance between two colors in the CIE Lab color space. That is, when the distance is long, the color difference is large, and when the distance is short, there color difference is accordingly negligible. This color difference is represented by ΔE. According to the description above, the body 110 and the cover 120 have a color difference (ΔE) equal to or greater than 30, or equal to or greater than 50.

If the color difference between the body 110 and the cover 120 is less than 30, it may become difficult to distinguish the body 110 and the cover 120 from each other, Separately from the molded product described above, a molded product may include a body made of a light-shielding photosensitive resin composition; and a cover made of a light-shielding thermosetting resin composition in which the transmittance difference (% T) between the body and the cover is greater than or equal to 6%.

If the transmittance difference (% T) between the body 110 and the cover 120 is less than 6%, the distinction of the body 110 and the cover 120 may become difficult to discern.

Accordingly, the transmittance difference (% T) between the body 110 and the cover 120 may also be, for example, in the range of 10% to 30%.

According to the above, the described molded product may be a high frequency multilayer inductor.

Referring to FIG. 7, a process for manufacturing a molded product may include preparing individual layers (S100); laying up the individual layers (S200); and post-treating the result (S300).

The step (S100) of preparing individual layers may include; forming a circuit on a substrate; bonding the body to the substrate on which the circuit is formed; forming via holes on the bonded substrate by exposure, development, and photolithography; and plating bumps to fill the vias of the via holes.

Here, the body may be made of a light-shielding photosensitive resin composition as described above.

The substrate may include, but is not limited to, a ceramic, especially a low temperature cured ceramic (LTCC), an aluminum ceramic (alumina), bismuthimide triazine resin, polyphenylene ether, polyimide resin, glass epoxy, GaAs, InP, FR4, silicon, glass cloth, or a mixture thereof, which can be used as an insulating substrate.

Accordingly, a carrier copper laminated film (CCL) disposed using a DCF method may be used for improving the flow of the product and improving the efficiency of productivity.

The circuits of the individual layers may be formed by a process of plating the substrate with DFR (dry film resist) bonding, an exposure process, a development process, and a Cu plating process.

The exposure process can be a contact exposure using a negative mask having a defined exposure pattern, or a non-contact exposure, but a contact exposure may have better resolution. As the exposure environment, a vacuum or a nitrogen atmosphere may be used. As the exposure light source, a halogen lamp, a high-pressure mercury lamp, a laser beam, a metal halide lamp, a black lamp, an electrodeless lamp, or the like may be used. The exposure suitable for producing the above-described substrate may be in a range from 100 J to 400 J.

The developing process is not limited thereto. For example, the developing process may be performed by using an alkali solution.

A light-shielding photosensitive insulation film may be bonded to the substrate on which the circuit is formed, and via holes may be formed. The method of forming the via holes may include exposure, development and photo-curing processes.

The curing process may be performed at a temperature in the range of 150 to 230° C., but is not limited thereto.

The curing temperature may be lower than the melting temperature of the hollow silica particles such that the silica particles are not melted.

The substrate on which the via holes are formed is subjected to a bump plating process for filling vias with Cu and Sn.

The substrate on which the plating process is completed may separate the DCF and etch the carrier Cu to complete the manufacture of each individual layer.

The thickness of the individual layers may be, but is not limited to, 10 to 30 μm per each layer.

The individual layers thus prepared may be subjected to a lay-up lamination (S200), followed by a post-treatment step (S300). Lay-up lamination may be more economic and convenient than the sequential lamination.

The lay-up laminating may be performed by matching lamination and thermosetting processes after attaching a plurality of individual layers and laying up a thermosetting cover material (cover film) as described above on the upper and lower sides.

The lay-up laminated molded product may be completed through cutting such as dicing, polishing, and post-treating of Ni and/or Sn plating (S300).

Hereinafter, examples will be presented, but the scope of the present disclosure is not limited thereto.

### EXAMPLES

### Method for Manufacturing a Light-Sensitive Resin Composition and a Film

### Example 1

20 Parts by weight of a carboxyl group-containing resin, 2.0 parts by weight of a photopolymerization initiator, 1.6 parts by weight of a compound having an ethylenic unsaturated group, 12 parts by weight of a thermosetting resin, 0.4 parts by weight of a pigment disclosed above, and 64 parts by weight of silica were uniformly dissolved and mixed to provide a light-sensitive insulating film having a consistent thickness of 20 μm. The film was cured in an exposure amount in the range of 100 to 400 mJ and a temperature range of 150 to 230° C.

### Comparative Examples 1-5

Films were prepared under the same conditions in Example 1, except for type and content of the pigment (see Table 1).

TABLE 1

| | | | Comparative | Comparative | Comparative | Comparative | Comparative |
|---|---|---|---|---|---|---|---|
| | | Example 1 | Example 1 | Example 2 | Example 3 | Example 4 | Example 5 |
| Pigment | Blue pigment | 0.4 | 0.2 | — | 0.3 | 0.1 | 0.34 |
| | Green pigment | — | 0.2 | 0.4 | 0.1 | 0.3 | — |

### Method for Manufacturing a Thermosetting Resin Composition and a Film

### Example 2

70 Parts by weight of an inorganic filler, 15 parts by weight of an epoxy resin, 5 parts by weight of a curing agent, 2 parts by weight of a polymer resin, 7 parts by weight of a pigment and 1 part by weight of other additives such as a dispersant or a curing accelerator were added into a solvent and the mixture was stirred to be 65% solid content. When completely dissolved, the varnish was applied on a PET film or a copper foil to a predetermined thickness and dried at a temperature of 70-100° C. to produce a thermosetting insulating film having a thickness of 20 μm or less.

### Comparative Example 6 to 9

Films were prepared under the same conditions in Example 2 except for type and content of the pigment and content of silica (see Table 2).

TABLE 2

| | | | Comparative | Comparative | Comparative | Comparative |
|---|---|---|---|---|---|---|
| | | Example 2 | Example 6 | Example 7 | Example 8 | Example 9 |
| Pigment | White pigment | 7 | — | — | — | — |
| | Black pigment | — | — | 5 | — | — |
| | Green pigment | — | — | — | 5 | — |
| | Yellow pigment | — | — | — | — | 10 |
| Silica | | 70 | 72 | 70 | 70 | 65 |

CIE L*a*b*-Colorimetric Test

The CIE L*a*b* of the films according to Examples and Comparative Examples were measured using CIE L*a*b* Spectroeye (portable spectrophotometer of Xrite) (see Table 3 and Table 4).

Table 3 shows L, a*, and b* values of the body molded with the photosensitive composition of Example 1 and Comparative Examples 1 to 5 and a directed transmittance (% T) at a wavelength band of 600 nm.

As shown in Table 3, it is noted that the body molded with the photosensitive composition of Example 1 has an L value of 40 or less, an a* value of −40 to −10, a b* value of 5 or less and a directed transmittance (% T) of 10% or less at a wavelength band of 200 nm to 700 nm. As a result, there is no show-through problem of circuits. On the other hand, the films molded with the photosensitive composition of Comparative Examples 1 to 5 cause show-through problem of circuits. For example, even though the same blue pigment is used in Comparative Example 5 as used in to Example 1, the a* value exceeds the range of −40 to −10, resulting in show-through problem of circuits.

TABLE 3

| | | Comparative | Comparative | Comparative | Comparative | Comparative |
|---|---|---|---|---|---|---|
| | Example 1 | Example 1 | Example 2 | Example 3 | Example 4 | Example 5 |
| L | 29.04 | 33.58 | 71.12 | 40.68 | 41.58 | 32.09 |
| a* | −11.66 | −6.69 | −34.56 | −38.16 | −28 | −6.47 |
| b* | −16.71 | 0.19 | −7.69 | −8.36 | 6 | −9.04 |
| % T@600 nm | 2.8 | 8.6 | 10.1 | 4.6 | 9.8 | 3.9 |
| Show-through | X | ◯ | ◯ | ◯ | ◯ | ◯ |
| of circuits | | | | | | |

Table 4 shows L, a*, and b* values of the cover molded with the thermosetting composition of Example 2 of the present disclosure and Comparative Examples 6 to 9 and a directed transmittance (% T) at a wavelength band of 600 nm.

As shown in Table 4, it is noted that the cover molded with the thermosetting composition of Example 2 has the tinting strength of an L value of 40 to 100, an a* value of −6 to 100, a b* value of 30 or less, and a directed transmittance (% T) of 1% or less at a wavelength band of 200 nm to 700 nm, and does not cause show-through problem of circuits. Thus, even when W and T are the same, the body and the cover are distinguished from each other. On the other hand, the films molded with the thermosetting composition of Comparative Example 6, 8, and 9 cause show-through problems of circuits. In the films molded with the thermosetting composition of Comparative Examples 7 and 8, when W and T are the same, the body and the cover cannot be distinguished from each other.

TABLE 4

| | | Comparative | Comparative | Comparative | Comparative |
|---|---|---|---|---|---|
| | Example 2 | Example 6 | Example 7 | Example 8 | Example 9 |
| L | 92.21 | 87.27 | 42.59 | 34.55 | 76.59 |
| a* | −1.23 | 0.47 | −6.47 | −5.12 | 10 |
| b* | 0.31 | 34.08 | 3.76 | 4.5 | 28 |
| % T@600 nm | 0.32 | 2.1 | 1.05 | 0.41 | 2.22 |
| Show-through | X | ◯ | X | ◯ | ◯ |
| of circuits | | | | | |
| W/T Distinction | ◯ | ◯ | X | X | ◯ |

Transmittance Test (UV-Vis Spectrum Measurement)

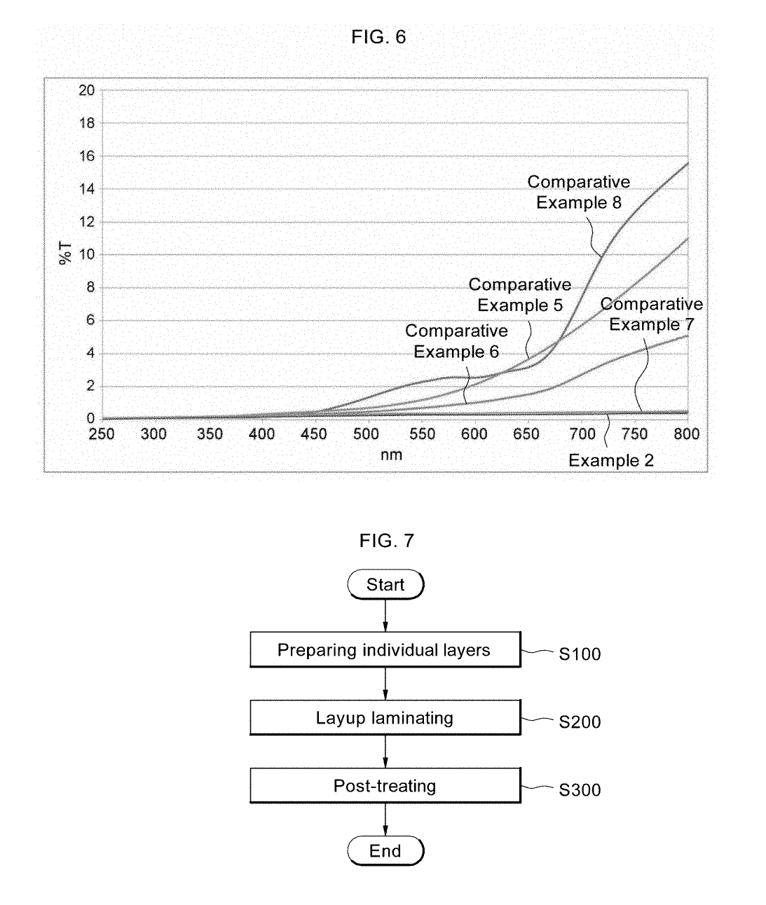

Directed transmittances (% T) of the films according to Examples and Comparative Examples were measured using PerkinElmer Lambda 1050 and results are shown in FIG. 5 and FIG. 6.

FIG. 5 shows that the color photosensitive resin films of Example 1 having a composition in accordance with exemplary embodiments described above have a directed transmittance (% T) of less than 10% at a wavelength range of about 600 nm to 750 nm. On the other hand, the color photosensitive resin films of Comparative Examples 1 to 4 show a transmittance of 10% or more.

FIG. 6 shows that the thermosetting film of Example 2 having a composition in accordance with exemplary embodiments described above has a transmittance of 1% or less at a wavelength range of about 200 nm to about 650 nm.

In accordance with the above, exemplary embodiments provide a light-shielding photosensitive resin composition and a thermosetting resin composition having a specific range of tinting strength and transmittance to simultaneously improve light shielding property and resolution, thereby solving a show-through problem of circuits when the appearance is inspected.

The above description provides a body material, a cover material, and a molded product comprising the same and a method for manufacturing the same by using a large light-shielding photosensitive resin composition and a thermosetting resin composition having high differences in color and transmittance to determine appearance and direction of the molded article even if the width (W) and the thickness (T) are identical or colors of the top and sides are similar.

Thus, according to the above, there is provided a photosensitive resin composition and a light-shielding thermosetting resin composition which is able to form an insulating layer having high tinting strength and excellent resolution. Further, there is provided a molded product with simultaneously improved tinting strength and resolution. There is provided a molded product which is able to determine appearance and direction even if the width (W) and the thickness (T) are the same. There is provided a molded product which is able to determine appearance and direction even if colors of the top and sides are the same or similar. There is provided a molded product which is able to determine cracks and has excellent light-shielding at the same time. There is provided a film using the resin composition that satisfies both high resolution and excellent light-shielding, which can be used in high frequency inductors that are miniaturized, thinned and densified.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents, Therefore, the scope of the disclosure is defined not by the detailed description, but by the claims and their equivalents, and all variations within the scope of the claims and their equivalents are to be construed as being included in the disclosure.

What is claimed is:

1. A molded product, comprising:
a body comprising a light-shielding photosensitive resin,
wherein:
the light-shielding photosensitive resin has a tinting strength having an L value equal than or less than 40, an a* value of −40 to −10, and a b* value less than or equal to 5 in the L*a*b* color space (CIE colorimetric system); and
the light-shielding photosensitive resin has a directed transmittance (% T) of less than 10% at a wavelength band of 200 nm to 700 nm.

2. The molded product of claim 1, wherein the light-shielding photosensitive resin has a directed transmittance (% T) of less than 5% at a wavelength range of 200 nm to 700 nm.

3. The molded product of claim 1, wherein the light-shielding photosensitive resin comprises a carboxyl group-containing resin, a photopolymerization initiator, a diluting solvent, a photopolymerizable compound having an ethylenic unsaturated group, a thermosetting epoxy resin, a pigment, and an inorganic filler.

4. The molded product of claim 3, wherein the pigment in the light-shielding photosensitive resin is present in an amount or less than or equal to 2 parts by weight based on the total weight of solid content.

5. The molded product of claim 3, wherein the inorganic filler in the light-shielding photosensitive resin comprises spherical silica present in an amount greater than or equal to 60 parts by weight based on the total weight of solid content.

6. The molded product of claim 5, wherein the spherical silica has an average particle diameter of 500 nm to 1 μm.

7. The molded product of claim 6, wherein the maximum particle diameter of the spherical silica is less than 5 μm.

8. The molded product of claim 1, wherein the light-shielding photosensitive resin comprises an alkali developable light-shielding photosensitive resin.

9. A molded product, comprising:
a cover comprising a light-shielding thermosetting resin,
wherein:
the light-shielding thermosetting resin has a tinting strength of an L value of 40 to 100, an a* value of −6 or more, and a b* value of 30 or less in the L*a*b* color space (CIE colorimetric system); and
the light-shielding thermosetting resin has a directed transmittance (% T) of less than 1% at a wavelength band of 200 nm to 700 nm.

10. The molded product of claim 9, wherein the light-shielding thermosetting resin has a directed transmittance (% T) of 0.5% or less at a wavelength range of 200 nm to 700 nm.

11. The molded product of claim 9, wherein the light-shielding thermosetting resin comprises 60 to 80 parts by weight of an inorganic filler, 10 to 20 parts by weight of an epoxy resin, 0 to 10 parts by weight of a curing agent, 0 to 3 parts by weight of a polymer resin, and 0 to 10 parts by weight of a pigment based on the total weight of solid content.

12. The molded product of claim 11, wherein the inorganic filler comprises spherical silica having an average particle diameter of 500 nm to 5 μm.

13. The molded product of claim 12, wherein the maximum particle diameter of the spherical silica is 10 μm or less.

14. A molded product, comprising:
a body comprising a light-shielding photosensitive resin; and
a cover covering one or more surfaces of the body, the cover comprising a light shielding thermosetting resin,
wherein:
the light-shielding photosensitive resin has a tinting strength having an L value equal than or less than 40, an a* value of −40 to −10, and a b* value less than or equal to 5 in the L*a*b* color space (CIE colorimetric system);
the light-shielding photosensitive resin has a directed transmittance (% T) of less than 10% at a wavelength band of 200 nm to 700 nm;
the light-shielding thermosetting resin has a tinting strength of an L value of 40 to 100, an a* value of −6 or more, and a b* value of 30 or less in the L*a*b* color space (CIE colorimetric system); and
the light-shielding thermosetting resin has a directed transmittance (% T) of less than 1% at a wavelength band of 200 nm to 700 nm.

15. The molded product of claim 14, wherein the body and the cover have a color difference (ΔE) greater than or equal to 30.

16. The molded product of claim 14, wherein the body and the cover have a color difference (ΔE) greater than or equal to 50.

17. The molded product of claim 14, wherein the transmittance difference (% T) between the body and the cover is greater than or equal to 6%.

18. The molded product of claim 18, wherein the transmittance difference (% T) between the body and the cover is 10% to 30%.

19. The molded product of claim 14, wherein the molded product is an inductor, a film, a printed circuit board, a light-shielding member, a chip, or a part for display on mobile phones or video devices.

20. The molded product of claim 14, wherein the molded product is a high frequency multilayer inductor having an equal width and thickness.

21. A method for inspecting a molded product, comprising:
forming a molded product comprising a body and a cover disposed to overlap the body; and
inspecting the molded product for defects,
wherein the body comprises a light-shielding photosensitive resin and the cover covers one or more surfaces of the body and comprises a light shielding thermosetting resin, and
wherein:
the light-shielding photosensitive resin has a tinting strength having an L value equal than or less than 40, an a* value of −40 to −10, and a b* value less than or equal to 5 in the L*a*b* color space (CIE colorimetric system);
the light-shielding photosensitive resin has a directed transmittance (% T) of less than 10% at a wavelength band of 200 nm to 700 nm;
the light-shielding thermosetting resin has a tinting strength of an L value of 40 to 100, an a* value of −6 or more, and a b* value of 30 or less in the L*a*b* color space (CIE colorimetric system); and
the light-shielding thermosetting resin has a directed transmittance (% T) of less than 1% at a wavelength band of 200 nm to 700 nm.

22. The method of claim 21, wherein the body and the cover have a color difference (ΔE) greater than or equal to 30.

23. The method of claim 21, wherein the body and the cover have a color difference (ΔE) greater than or equal to 50.
